(19) United States
(12) Patent Application Publication
(10) Pub. No.: US 2024/0054626 A1
(43) Pub. Date: Feb. 15, 2024

(54) PROCESSING DEVICE, ABNORMALITY DETECTION SYSTEM, ABNORMALITY DETECTION METHOD, AND COMPUTER-READABLE MEDIUM

(71) Applicant: NEC Corporation, Minato-ku, Tokyo (JP)

(72) Inventors: Yoshimasa ONO, Tokyo (JP); Akira TSUJI, Tokyo (JP)

(73) Assignee: NEC Corporation, Minato-ku, Tokyo (JP)

(21) Appl. No.: 18/022,668

(22) PCT Filed: Aug. 28, 2020
(86) PCT No.: PCT/JP2020/032595

§ 371 Date: Aug. 24, 2023

(51) Int. Cl. G06T 7/00; G06T 7/73

(52) U.S. Cl. CPC G06T 7/0002; G06T 7/74; G06T 2207/10028

(57) ABSTRACT

Provided is a processing device capable of accurately identifying an abnormal part. A processing device (1) according to the present disclosure includes a first difference calculation unit (11) that calculates a difference between a plurality of reference point groups, a dynamic point group extraction unit (15) that extracts a dynamic point group being a point group involving a change from the reference point groups on the basis of a calculation result in the first difference calculation unit (11), a second difference calculation unit (12) that calculates a difference between an inspection point group acquired after the reference point group and the reference point group and generates a differential point group, a point group removal unit (16) that removes a point group corresponding to the dynamic point group from the differential point group generated in the second difference calculation unit (12), and an abnormal part identification unit (17) that identifies an abnormal part of the object to be measured on the basis of a differential point group from which the point group corresponding to the dynamic point group is removed.

### TECHNICAL FIELD

The present disclosure relates to a processing device, an abnormality detection system, an abnormality detection method, and a computer-readable medium.

### BACKGROUND ART

A LiDAR (Light Detection and Ranging) device is one of devices that acquire three-dimensional position information of an object to be measured. The LiDAR device acquires three-dimensional position information of an object to be measured by using the distance from the LiDAR device to the object to be measured, the intensity of reflection, and the current position of the LiDAR device.

Patent Literature 1 discloses a technique related to a surveillance device that recognizes an object existing in a surveillance area. The technique disclosed in Patent Literature 1 extracts a change region by using a measurement result of the surveillance area measured by a three-dimensional laser scanner and a measurement result measured in the past.

Patent Literature 2 discloses a technique related to an image detection device that can improve the capability of responding to the deformation of an object by optimizing a template shape when detecting the object using template matching.

### CITATION LIST

### Patent Literature

Patent Literature 1: Japanese Unexamined Patent Application Publication No. 2019-046295

Patent Literature 2: International Patent Publication No. WO 2017-170087

### SUMMARY OF INVENTION

### Technical Problem

When detecting an abnormal part in an object to be measured by using the LiDAR device, a reference point group of the object to be measured is acquired by measuring the three-dimensional position information of the object to be measured in advance. Then, an inspection point group of the object to be measured is acquired by measuring the three-dimensional position information of the object to be measured at the time of inspection. After that, a difference between the inspection point group and the reference point group of the object to be measured is calculated, and a part where the calculated difference is equal to or more than a predetermined threshold is identified as an abnormal part.

However, in the case of identifying an abnormal part by using this technique, there is a possibility that an object that is displaced during measurement or displaced with time is also identified as an abnormal part. Thus, a part that is not an abnormal part can be wrongly detected as an abnormal part, which hinders accurate identification of an abnormal part.

An object of the present disclosure is to provide a processing device, an abnormality detection system, an abnormality detection method, and a computer-readable medium that solve any of the above-described problems.

### Solution to Problem

A processing device according to the present disclosure includes a first difference calculation unit configured to calculate a difference between a plurality of reference point groups corresponding to three-dimensional position information of an object to be measured; a dynamic point group extraction unit configured to extract a dynamic point group being a point group involving a change from the reference point groups on the basis of a calculation result in the first difference calculation unit; a second difference calculation unit configured to calculate a difference between an inspection point group acquired after the reference point group and corresponding to three-dimensional position information of the object to be measured and the reference point group, and generate a differential point group; a point group removal unit configured to remove a point group corresponding to the dynamic point group from the differential point group generated in the second difference calculation unit; and an abnormal part identification unit configured to identify an abnormal part of the object to be measured on the basis of a differential point group from which the point group corresponding to the dynamic point group is removed.

An abnormality detection system according to the present disclosure includes a position information acquisition device configured to acquire three-dimensional position information of an object to be measured; and a processing device configured to identify an abnormal part of the object to be measured by using three-dimensional position information acquired in the position information acquisition device. The processing device includes a first difference calculation unit configured to calculate a difference between a plurality of reference point groups corresponding to three-dimensional position information of the object to be measured; a dynamic point group extraction unit configured to extract a dynamic point group being a point group involving a change from the reference point groups on the basis of a calculation result in the first difference calculation unit; a second difference calculation unit configured to calculate a difference between an inspection point group acquired after the reference point group and corresponding to three-dimensional position information of the object to be measured and the reference point group, and generate a differential point group; a point group removal unit configured to remove a point group corresponding to the dynamic point group from the differential point group generated in the second difference calculation unit; and an abnormal part identification unit configured to identify an abnormal part of the object to be measured on the basis of a differential point group from which the point group corresponding to the dynamic point group is removed.

An abnormality detection method according to the present disclosure includes calculating a difference between a plurality of reference point groups corresponding to three-dimensional position information of an object to be measured; extracting a dynamic point group being a point group involving a change from the reference point groups on the basis of a result of the calculation; calculating a difference between an inspection point group acquired after the reference point group and corresponding to three-dimensional position information of the object to be measured and the reference point group, and generating a differential point group; removing a point group corresponding to the dynamic point group from the generated differential point group; and identifying an abnormal part of the object to be measured on the basis of a differential point group from which the point group corresponding to the dynamic point group is removed.

A computer-readable medium according to the present disclosure is a non-transitory computer readable medium storing a program causing a computer to execute an abnormality detection process including calculating a difference between a plurality of reference point groups corresponding to three-dimensional position information of an object to be measured; extracting a dynamic point group being a point group involving a change from the reference point groups on the basis of a result of the calculation; calculating a difference between an inspection point group acquired after the reference point group and corresponding to three-dimensional position information of the object to be measured and the reference point group, and generating a differential point group; removing a point group corresponding to the dynamic point group from the generated differential point group; and identifying an abnormal part of the object to be measured on the basis of a differential point group from which the point group corresponding to the dynamic point group is removed.

### Advantageous Effects of Invention

According to the present disclosure, there are provided a processing device, an abnormality detection system, an abnormality detection method, and a computer-readable medium capable of accurately identifying an abnormal part.

### BRIEF DESCRIPTION OF DRAWINGS

FIG. 1 is a block diagram showing the configuration of an abnormality detection system according to a first example embodiment.

FIG. 2 is a block diagram showing the configuration of a processing device according to the first example embodiment.

FIG. 3 is a flowchart illustrating the operation of the processing device according to the first example embodiment.

FIG. 4 is a view illustrating the operation of the processing device according to the first example embodiment.

FIG. 5 is a view illustrating the operation of the processing device according to the first example embodiment.

FIG. 6 is a view illustrating the operation of the processing device according to the first example embodiment.

FIG. 7 is a view illustrating the operation of the processing device according to the first example embodiment.

FIG. 8 is a view illustrating the operation of the processing device according to the first example embodiment.

FIG. 9 is a view illustrating the operation of the processing device according to the first example embodiment.

FIG. 10 is a view illustrating the operation of the processing device according to the first example embodiment.

FIG. 11 is a block diagram showing the configuration of a processing device according to a second example embodiment.

FIG. 12 is a flowchart illustrating the operation of the processing device according to the second example embodiment.

FIG. 13 is a view illustrating the operation of the processing device according to the second example embodiment.

FIG. 14 is a view illustrating the operation of the processing device according to the second example embodiment.

FIG. 15 is a view illustrating a processing device according to a third example embodiment.

FIG. 16 is a view illustrating the processing device according to the third example embodiment.

FIG. 17 is a flowchart illustrating the operation of the processing device according to the third example embodiment.

### EXAMPLE EMBODIMENT

### First Example Embodiment

An example embodiment of the present invention will be described hereinafter with reference the drawings.

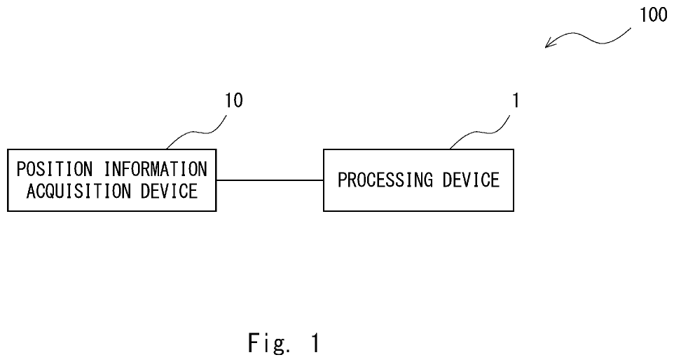

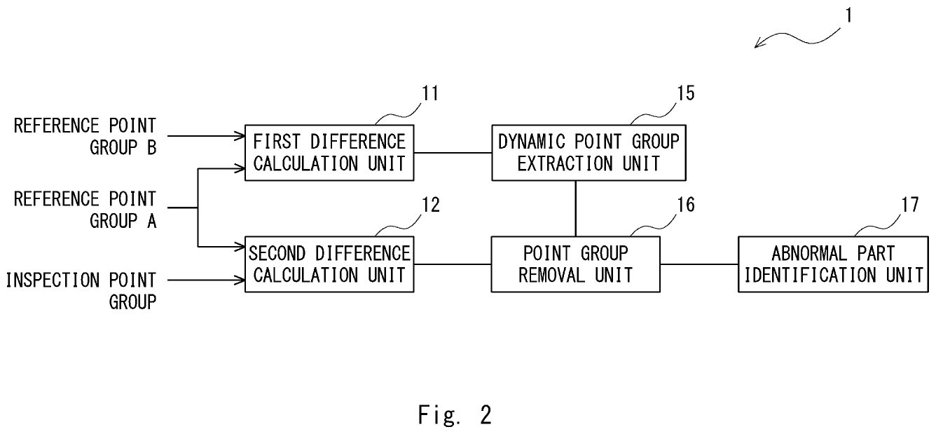

FIG. 1 is a block diagram showing the configuration of an abnormality detection system according to a first example embodiment. FIG. 2 is a block diagram showing the configuration of a processing device according to the first example embodiment. As shown in FIG. 1, an abnormality detection system 100 according to this example embodiment includes a position information acquisition device 10 and a processing device 1. The position information acquisition device 10 is a device that acquires three-dimensional position information of an object to be measured. The position information acquisition device 10 is a LiDAR device, for example. The processing device 1 identifies an abnormal part of the object to be measured by using the three-dimensional position information acquired in the position information acquisition device 10.

As shown in FIG. 2, the processing device 1 according to this example embodiment includes a first difference calculation unit 11, a second difference calculation unit 12, a dynamic point group extraction unit 15, a point group removal unit 16, and an abnormal part identification unit 17. The processing device 1 according to this example embodiment is a device that receives reference point groups A and B and an inspection point group corresponding to three-dimensional position information of an object to be measured, and identifies an abnormal part of the object to be measured by using the reference point groups A and B and the inspection point group.

The reference point groups A and B are point groups corresponding to three-dimensional position information of an object to be measured, which are point groups acquired in advance in order to obtain a point group (dynamic point group) involving a change in the object to be measured. The inspection point group is a point group corresponding to three-dimensional position information of an object to be measured, which is a point group acquired when inspecting an abnormal part of the object to be measured (i.e., acquired after the reference point groups). The point group corresponds to three-dimensional position information of an object to be measured, and it contains information such as the distance from the position information acquisition device (LiDAR device) 10 to the object to be measured, the intensity of reflection, and three-dimensional coordinates.

The processing device 1 according to this example embodiment calculates a difference between the inspection point group and the reference point group of an object to be measured and identifies an abnormal part by using the calculated difference. In this processing, the processing device 1 according to this example embodiment extracts a point group (dynamic point group) involving a change from the reference point group by using the reference point groups A and B. The processing device 1 then calculates a difference between the inspection point group and the reference point group and generates a differential point group, removes a point group corresponding to the dynamic point group from this generated differential point group, and identifies an abnormal part of the object to be measured on the basis of a differential point group from which the point group corresponding to the dynamic point group is removed. The processing device 1 according to this example embodiment is described hereinafter in detail.

The first difference calculation unit 11 shown in FIG. 2 calculates a difference between a plurality of reference point groups corresponding to three-dimensional position information of an object to be measured. In the example shown in FIG. 2, the first difference calculation unit 11 calculates a difference between the reference point group A and the reference point group B. The reference point group A and the reference point group B are three-dimensional point groups, and the first difference calculation unit 11 calculates a difference between the reference point group A and the reference point group B at each coordinates.

The dynamic point group extraction unit 15 extracts a point group (dynamic point group) involving a change from the reference point group on the basis of the calculation result in the first difference calculation unit 11. To be specific, the dynamic point group extraction unit 15 extracts a displaced part (dynamic point group) between the reference point groups A and B on the basis of the calculation result of a difference between the reference point group A and the reference point group B at each coordinates. For example, in this example embodiment, the dynamic point group extraction unit 15 may extract a displaced part on the basis of the presence or absence of a point group in voxels of the two reference point groups A and B.

The second difference calculation unit 12 calculates a difference between an inspection point group corresponding to three-dimensional position information of the object to be measured and the reference point group, and generates a differential point group. The inspection point group is a point group acquired after the reference point group, and it is a point group acquired when inspecting an abnormal part of the object to be measured, for example. The reference point group used at this time may be any one of the reference point group A and the reference point group B. In this specification, an example where the second difference calculation unit 12 calculates a difference between the inspection point group and the reference point group A is shown. The inspection point group and the reference point group A are three-dimensional point groups, and the second difference calculation unit 12 calculates a difference between the inspection point group and the reference point group A at each coordinates.

The point group removal unit 16 removes a point group corresponding to the dynamic point group extracted in the dynamic point group extraction unit 15 from the differential point group generated in the second difference calculation unit 12. For example, the point group removal unit 16 removes a point group corresponding to the dynamic point group from the differential point group when the distance between the differential point group and the dynamic point group is equal to or less than a predetermined threshold. The details of the point group removal unit 16 are described later.

The abnormal part identification unit 17 identifies an abnormal part of the object to be measured on the basis of a differential point group from which the point group corresponding to the dynamic point group is removed in the point group removal unit 16. For example, the abnormal part identification unit 17 may identify, as an abnormal part, a part where a difference between the inspection point group and the reference point group A (excluding the point group removed in the point group removal unit 16) of the object to be measured is equal to or more than a predetermined threshold. Specifically, a difference between the inspection point group and the reference point group A of the object to be measured corresponds to a position where a change has occurred from the timing of measuring the reference point group A to the timing of measuring the inspection point group. Thus, the abnormal part identification unit 17 may identify, as an abnormal part, a part where such a change (difference) is equal to or more than a predetermined threshold.

An operation (abnormality detection method) of the processing device according to this example embodiment will be described hereinafter.

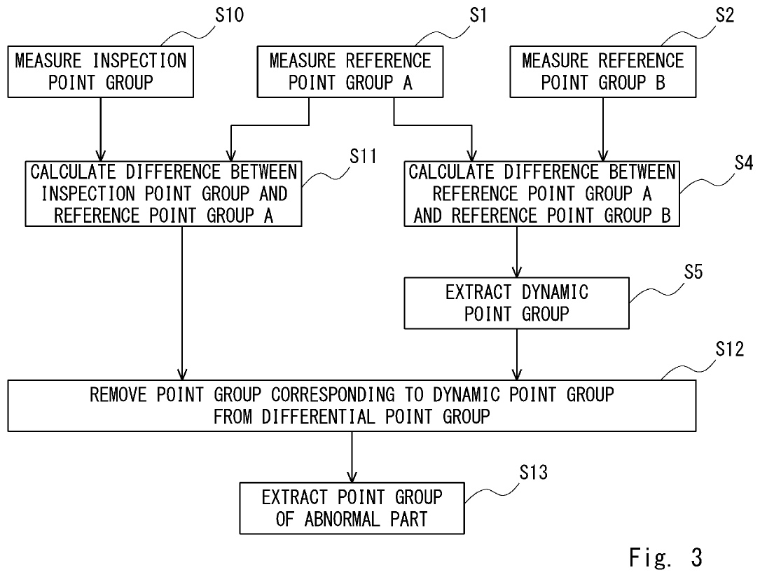

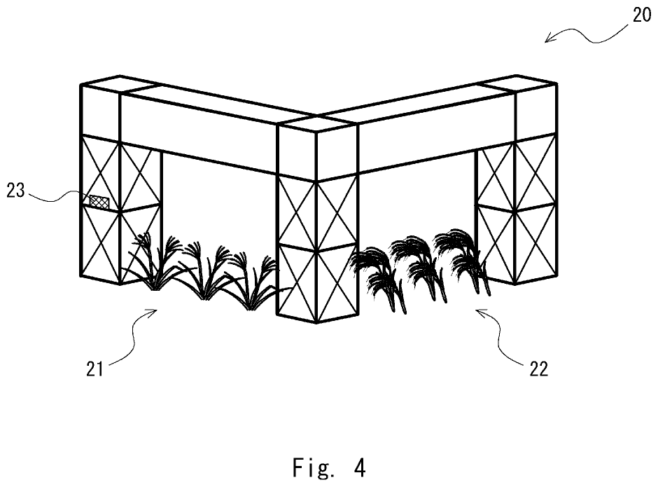

FIG. 3 is a flowchart illustrating the operation of the processing device according to this example embodiment. FIGS. 4 to 7 are views illustrating the operation of the processing device according to this example embodiment.

In this example embodiment, an example of measuring an object 20 to be measured shown in FIG. 4 is described. Assume that plants (grass) 21 and 22 are grown around the object 20 to be measured. Assume also that there is an abnormal part 23 in the object 20 to be measured at the time of inspection. Assume further that there is no abnormal part 23 at the time of acquiring the reference point group.

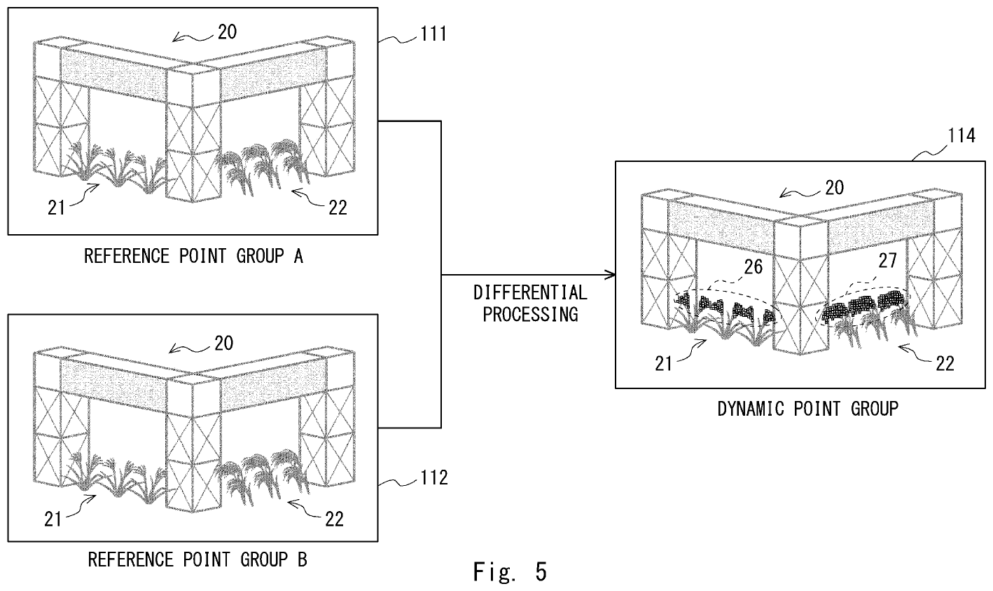

In this example embodiment, the reference point groups A and B, which are point groups corresponding to three-dimensional position information of the object to be measured, are acquired in advance by using the position information acquisition device 10 (see FIG. 1) (Steps S1 and S2). To be specific, the object to be measured shown in FIG. 4 is measured using the position information acquisition device 10, and thereby the reference point group A(111) and the reference point group B(112) shown in FIG. 5 are acquired. Note that, as for the timing of acquiring the reference point groups A and B, the reference point group A may precede or the reference point group B may precede.

After that, a difference between the reference point group A and the reference point group B is calculated using the first difference calculation unit 11 of the processing device 1 (Step S4). The reference point group A and the reference point group B are three-dimensional point groups, and the first difference calculation unit 11 calculates a difference between the reference point group A and the reference point group B at each coordinates. To be specific, as shown in FIG. 5, the calculation unit 11 calculates a difference between the reference point group A(111) and the reference point group B(112) and generates a differential point group 114.

Next, the dynamic point group extraction unit 15 extracts a dynamic point group, which is a point group involving a change, from the reference point group on the basis of the calculation result (the differential point group 114) in the first difference calculation unit 11 (Step S5). In other words, the dynamic point group extraction unit 15 extracts a displaced part between the reference point groups A and B on the basis of the calculation result (the differential point group 114) of a difference between the reference point group A and the reference point group B at each coordinates. To be specific, as shown in the differential point group 114 of FIG. 5, point groups of parts of the plants 21 and 22 that are displaced by wind are extracted as dynamic point groups 26 and 27.

By performing the above-described processing of Steps S1, S2, S4 and S5 in advance, the point group (dynamic point group) of the part that is displaced during measurement can be extracted from the object 20 to be measured shown in FIG. 4.

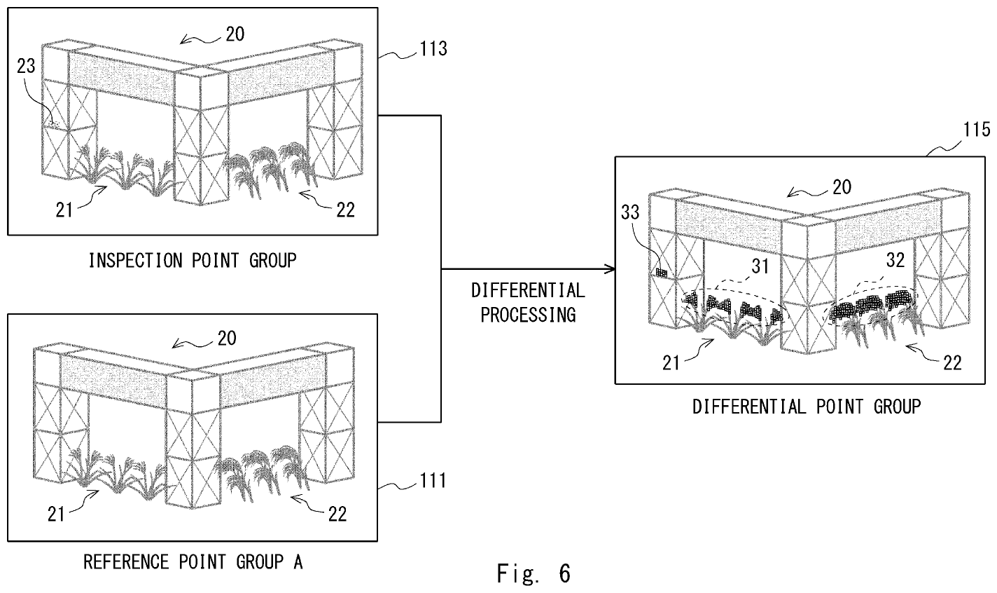

After that, in this example embodiment, the object 20 to be measured is inspected using the position information acquisition device 10 (see FIG. 1). To be specific, as shown in FIG. 6, an inspection point group 113 corresponding to three-dimensional position information of the object 20 to be measured is acquired using the position information acquisition device 10 (Step S10). In this example, the inspection point group 113 contains the abnormal part 23.

Then, the second difference calculation unit 12 of the processing device 1 calculates a difference between the inspection point group and the reference point group corresponding to three-dimensional position information of the object to be measured, and generates a differential point group (Step S11). The inspection point group and the reference point group are three-dimensional point groups, and the second difference calculation unit 12 calculates a difference between the inspection point group and the reference point group at each coordinates. To be specific, as shown in FIG. 6, the second difference calculation unit 12 calculates a difference between the inspection point group 113 and the reference point group A(111) and generates a differential point group 115. The differential point group 115 includes a point group 33 corresponding to the abnormal part 23 and point groups 31 and 32 corresponding to parts of the plants 21 and 22 displaced by wind.

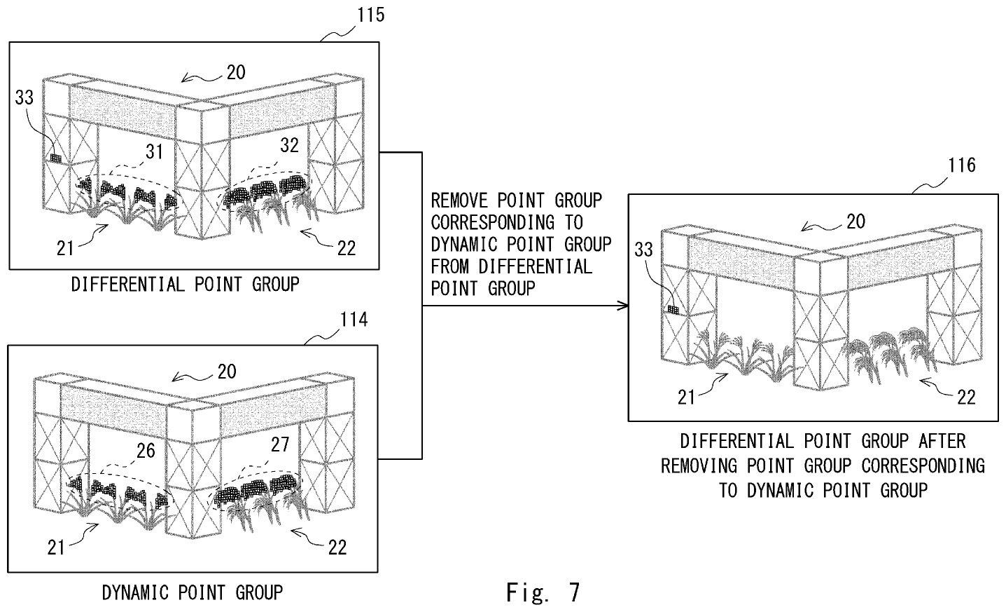

After that, the point group removal unit 16 removes a point group corresponding to the dynamic point group extracted in the dynamic point group extraction unit 15 from this differential point group generated in the second difference calculation unit 12 (Step S12). For example, the point group removal unit 16 removes a point group corresponding to the dynamic point group from the differential point group when the distance between the differential point group and the dynamic point group is equal to or less than a predetermined threshold. To be specific, as shown in FIG. 7, the point group removal unit 16 removes, from the differential point group 115, the point groups 31 and 32 corresponding to the dynamic point groups 26 and 27 included in the differential point group 114 and thereby generates a differential point group 116. Specifically, in the differential point group 116, the point groups 31 and 32 corresponding to the displaced parts of the plants 21 and 22 are removed from the differential point group 115.

After that, the abnormal part identification unit 17 identifies an abnormal part of the object to be measured on the basis of the differential point group from which the point group corresponding to the dynamic point group is removed in the point group removal unit 16 (Step S12). To be specific, as shown in FIG. 7, the abnormal part identification unit 17 identifies an abnormal part 33 of the object 20 to be measured on the basis of the differential point group 116 from which the point group corresponding to the dynamic point group is removed.

As described above, in this example embodiment, the dynamic point groups 26 and 27 are extracted from the reference point group by using the reference point groups A and B (see the differential point group 114). Then, the differential point group 115 is generated by calculating a difference between the inspection point group and the reference point group A, and the point groups 31 and 32 corresponding to the dynamic point groups 26 and 27 included in the differential point group 114 are removed from this generated differential point group 115. After that, the abnormal part 33 of the object 20 to be measured is identified on the basis of the differential point group 116 from which the point groups 31 and 32 involving a change are removed.

As described above, in this example embodiment, the point groups 31 and 32 involving a change are removed from the differential point group 115 between the inspection point group and the reference point group A. This prevents the point groups 31 and 32 involving a change from being wrongly detected as an abnormal part. This allows providing a processing device, an abnormality detection system, an abnormality detection method, and a computer-readable medium capable of accurately identifying an abnormal part.

Note that a point group (dynamic point group) involving a change is an object that is displaced during measurement or displaced with time, and it may be a plant leaf, a tree branch, looseness of equipment or the like, for example.

In this example embodiment, the point group removal unit 16 may set the predetermined threshold to be larger as the distance from a point of measurement (the position of the position information acquisition device 10; which is referred to also as a measurement point 10) to the object 20 to be measured is longer.

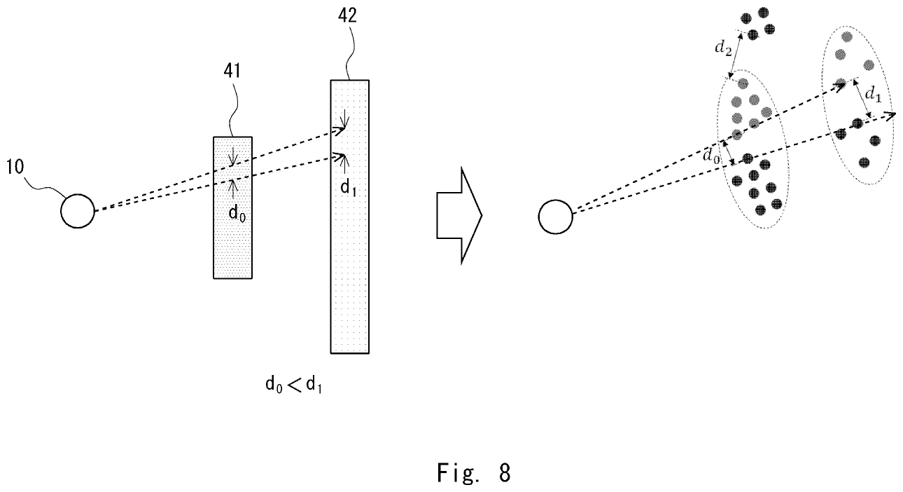

To be more specific, referring to FIG. 8, an interval d₀ of point groups of an object 41 to be measured and an interval d₁ of point groups of an object 42 to be measured are larger as the distance from the measurement point 10 to the object 41, 42 to be measured is longer. In the example shown in FIG. 8, since the distance from the measurement point 10 to the object 42 to be measured is longer than the distance from the measurement point 10 to the object 41 to be measured, the interval d₁ of point groups of the object 42 to be measured is larger than the interval d₀ of point groups of the object 41 to be measured (d₀<d₁).

Specifically, since laser light of the position information acquisition device 10 is emitted radially from the position information acquisition device 10, the interval between point groups increases in proportion to the distance from the measurement point 10 to the object 41, 42 to be measured. In this case, if a predetermined threshold dₜₕ is set to a constant value, a point group involving a change of the object 42 to be measured that is farther from the measurement point becomes less likely to be removed.

For example, since the object 42 to be measured is far from the measurement point 10, the interval d₁ of point groups tends to be large. In this case, the interval d₁ of point groups tends to be larger than the predetermined threshold d₀, (dₜₕ<d₁), and a point group involving a change of the object 42 becomes less likely to be removed. Further, in the case of the object 41 to be measured that is closer to the measurement point 10, the predetermined threshold dₜₕ is smaller than an interval d₂ from an adjacent point group (dₜₕ<d₂). In this case, there is a possibility that the point group of the object 41 to be measured is wrongly determined as a point group involving a change.

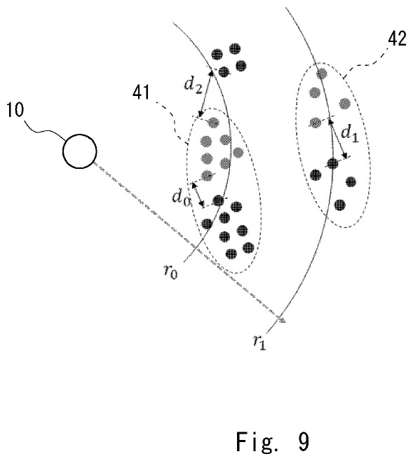

In view of this point, in this example embodiment, as shown in FIG. 9, the predetermined threshold dₜₕ may be set larger as the distance from the measurement point 10 to the object 41, 42 to be measured is longer. To be specific, when the distance from the measurement point 10 to the object 41 to be measured is r₀, the predetermined threshold dₜₕ is set so that the interval d₀ of point groups, the predetermined threshold dui, and the interval d₂ from an adjacent point group satisfy d₀<dₜₕ<d₂. Further, when the distance from the measurement point 10 to the object 42 to be measured is r₁, the predetermined threshold dₜₕ is set so that the interval d₁ of point groups and the predetermined threshold dₜₕ satisfy dₜₕ<d₁ For example, the predetermined threshold d₀, may be set so that the predetermined threshold dₜₕ is proportional to the distance from the measurement point 10 to the object 41, 42 to be measured.

Further, in this example embodiment, the point group removal unit 16 may set the predetermined threshold to be larger as the density of the reference point group is lower.

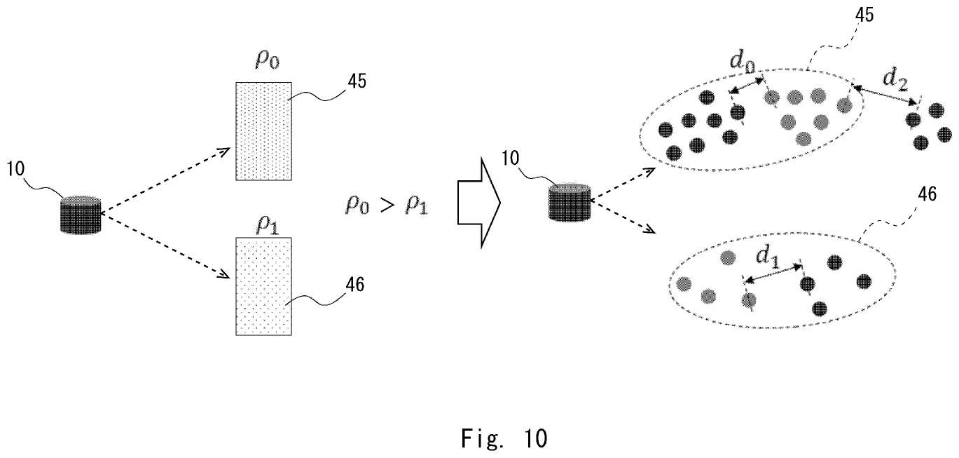

To be more specific, referring to FIG. 10, when density ρ₁ of an object 46 to be measured is lower than density ρ₀ of an object 45 to be measured (ρ₁<ρ₀), the interval d₁ of point groups of the object 46 to be measured is larger than the interval d₀ of point groups of the object 45 to be measured. For example, in the case of plants or the like, laser light passes through the plants without focusing thereon and is reflected by a structure in the back in some cases, and thereby the density of point groups is likely to be low (i.e., the interval of point groups is likely to be large). On the other hand, in the case of a structure having a plane such as a wall or ground, laser light is reflected by the plane, and thereby the density of point groups is likely to be high (i.e., the interval of point groups is likely to be small).

Therefore, if the predetermined threshold dₜₕ is set to a constant value, a point group with low density is less likely to be removed as a point group involving a change. For example, when the predetermined threshold dₜₕ is smaller than the interval d₁ of point groups of the object 46 to be measured (dₜₕ<d₁), plants with low density are not removed as a point group involving a change. Further, when the predetermined threshold dₜₕ is smaller than the interval d₂ from an adjacent point group (dₜₕ<d₂), there is a possibility that another structure is wrongly determined as a point group involving a change.

In view of this point, in this example embodiment, as shown in FIG. 10, the predetermined threshold dₜₕ may be set according to the density of the object 45, 46 to be measured. To be specific, the predetermined threshold may be set larger as the density of an object to be measured (the density of a reference point group) is lower. For example, the density of a reference point group can be calculated from the distance between points of the reference point group.

When the density of the object 45 to be measured is ρ₀, the predetermined threshold dₜₕ is set so that the interval d₀ of point groups, the predetermined threshold dₜₕ and the interval d₂ from an adjacent point group satisfy d₀<dₜₕ<d₂. Further, when the density of the object 45 to be measured is pi, the predetermined threshold dₜₕ is set so that the interval d₁ of point groups and the predetermined threshold dₜₕ satisfy dₜₕ<d₁ For example, the predetermined threshold dₜₕ may be set so that the predetermined threshold dₜₕ is proportional to the density p of the object to be measured.

By setting the predetermined threshold dₜₕ with use of the above-described method, a point group corresponding to the dynamic point group is accurately removed from the differential point group 115 (see FIG. 7).

### Second Example Embodiment

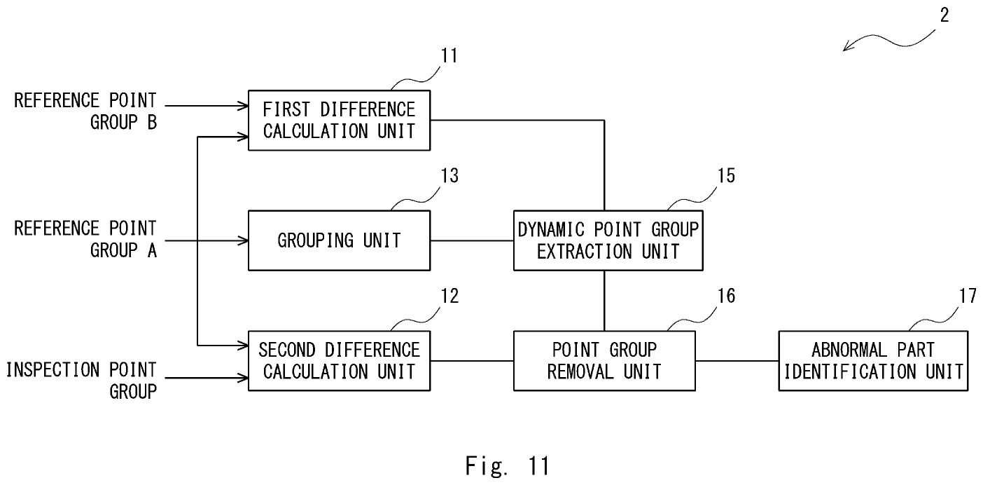

A second example embodiment will be described next. FIG. 11 is a block diagram showing the configuration of a processing device according to the second example embodiment. A processing device 2 according to the second example embodiment is different from the processing device 1 according to the first example embodiment in that it includes a grouping unit 13. The other configuration is the same as the processing device 1 according to the first example embodiment, and therefore the same elements are denoted by the same reference symbols and redundant description thereof is omitted.

As shown in FIG. 11, the processing device 2 according to this example embodiment includes the grouping unit 13 in addition to the configuration of the processing device 1 according to the first example embodiment. The grouping unit 13 groups point group elements that constitute a reference point group so as to include the similar point group elements. To be specific, the grouping unit 13 receives a reference point group A, groups point group elements that constitute the reference point group A so as to include the similar point group elements, and outputs the reference point group A after grouping to the dynamic point group extraction unit 15.

For example, the grouping unit 13 groups together the objects of the same type, the objects of the same color, the objects with the same density of point groups (see FIG. 10) and the like as the similar point group elements. Further, the grouping unit 13 may group together the point groups that are close to each other. Furthermore, the grouping unit 13 may group together the point group elements where the direction of the plane of each point group element is approximate to each other. Specifically, since each point group element contains information about the reflection intensity of laser light, the point group elements where the reflection intensity is approximate to each other may be grouped together as point group elements where the plane direction is approximate to each other. For example, since a road, a wall and the like have the same plane, they can be grouped as point group elements where the plane direction is approximate to each other.

The reference point group A after being grouped by the grouping unit 13 is supplied to the dynamic point group extraction unit 15. The dynamic point group extraction unit 15 extracts a dynamic point group, which is a point group involving a change, from the reference point group on the basis of the reference point group A after being grouped by the grouping unit 13 and the calculation result in the first difference calculation unit 11. The other elements of the processing device 2 are the same as those of the processing device 1 according to the first example embodiment, and therefore redundant description thereof is omitted.

An operation (abnormality detection method) of the processing device according to this example embodiment will be described hereinafter.

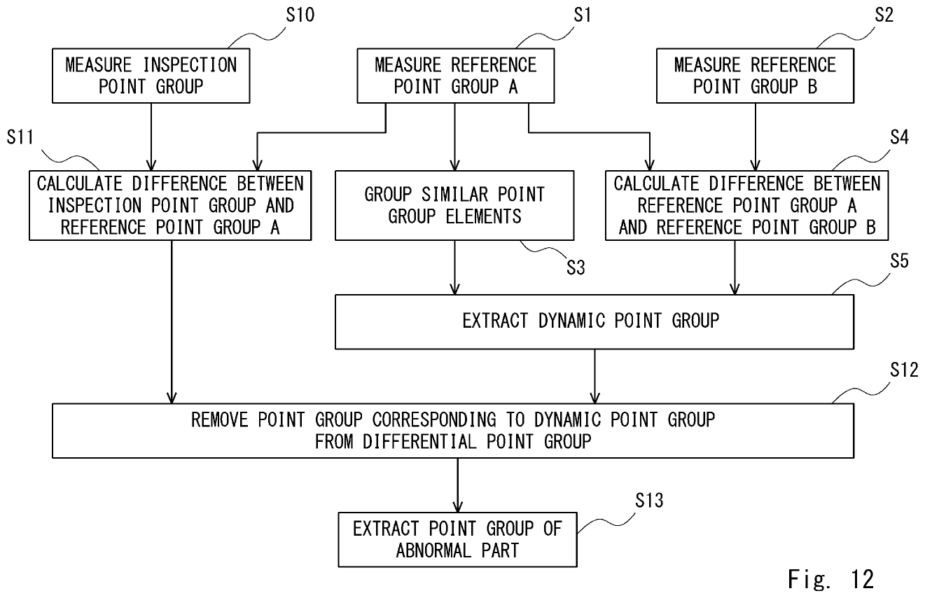

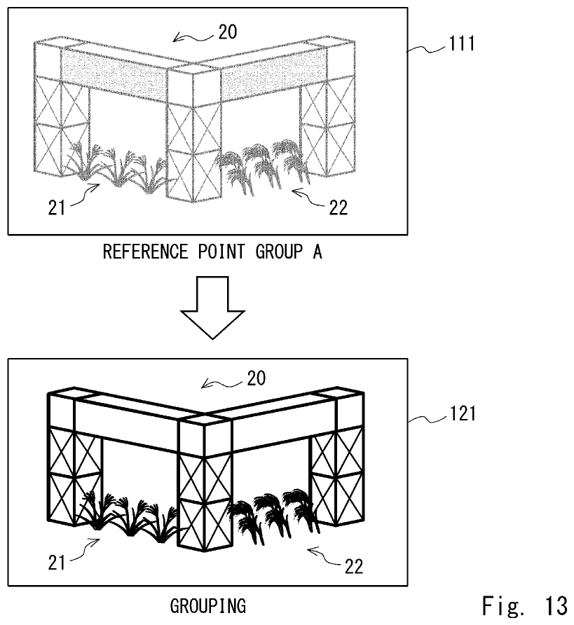

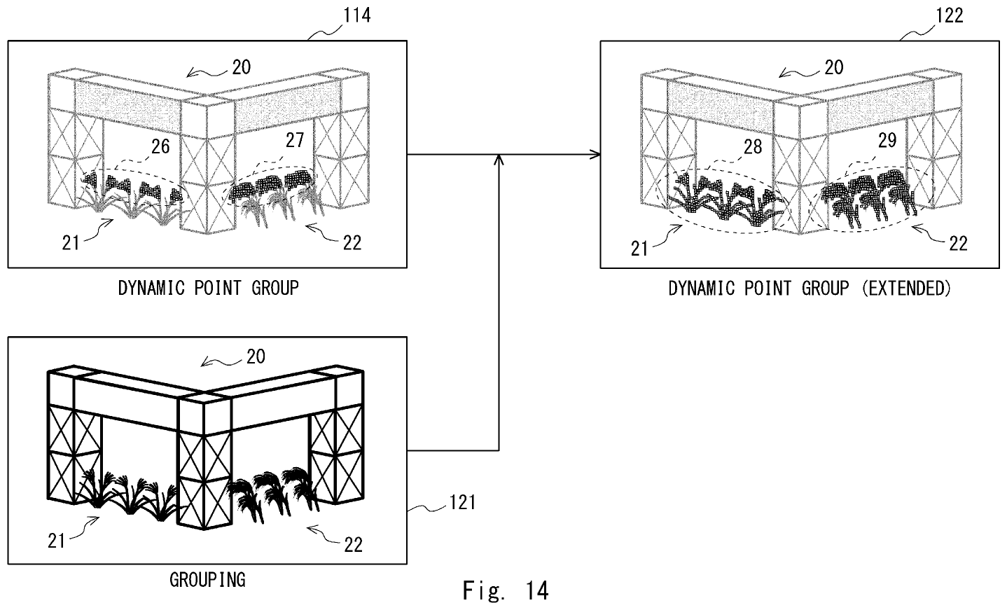

FIG. 12 is a flowchart illustrating the operation of the processing device according to this example embodiment. FIGS. 13 and 14 are views illustrating the operation of the processing device according to this example embodiment.

The operation of the processing device 2 according to this example embodiment shown in the flowchart of FIG. 12 is different from the operation of the processing device 1 according to the first example embodiment (FIG. 3) in that it includes Step S3. The other operation is the same as the operation of the processing device 1 according to the first example embodiment, and therefore redundant description thereof is omitted.

In this example embodiment also, the reference point groups A and B, which are point groups corresponding to three-dimensional position information of an object to be measured, are acquired in advance by using the position information acquisition device 10 (see FIG. 1) (Steps S1 and S2).

After that, the grouping unit 13 groups point group elements that constitute the reference point group A so as to include the similar point group elements (Step S3). To be specific, as shown in FIG. 13, the grouping unit 13 groups together each of an object to be measured (structure) 20, a plant 21, and a plant 22, which are included in the reference point group A(111), and generates a grouped reference point group A(121).

Then, the dynamic point group extraction unit 15 extracts a dynamic point group, which is a point group involving a change, from the reference point group on the basis of the grouped reference point group A(121) and the calculation result (the differential point group 114) in the first difference calculation unit 11 (Step S5). To be specific, as shown in FIG. 14, the dynamic point group extraction unit 15 refers to the grouped reference point group A(121) and extends the dynamic point groups 26 and 27 of the differential point group 114, and thereby generates (extended) dynamic point groups 28 and 29 (a differential point group 122).

In the example shown in FIG. 14, since the dynamic point group 26 of the differential point group 114 is included in the plant 21 after grouping, the dynamic point group extraction unit 15 extends the dynamic point group 26 so as to include the plant 21, and thereby generates the (extended) dynamic point group 28. Likewise, since the dynamic point group 27 of the differential point group 114 is included in the plant 22 after grouping, the dynamic point group extraction unit 15 extends the dynamic point group 27 so as to include the plant 22, and thereby generates the (extended) dynamic point group 29.

After that, in Step S12, the point group removal unit 16 removes, from the differential point group 115 (see FIG. 7), the point groups 31 and 32 corresponding to the (extended) dynamic point groups 28 and 29 included in the differential point group 122 (see FIG. 14), and thereby generates a differential point group 116. In the differential point group 116, the point groups corresponding to the plants 21 and 22 are removed.

After that, the abnormal part identification unit 17 identifies an abnormal part of the object to be measured on the basis of the differential point group from which the point group corresponding to the dynamic point group is removed in the point group removal unit 16 (Step S13 in FIG. 12). To be specific, as shown in FIG. 7, the abnormal part identification unit 17 identifies an abnormal part 33 of the object 20 to be measured on the basis of the differential point group 116 from which the point group corresponding to the dynamic point group is removed.

As described above, in this example embodiment, the grouping unit 13 groups point group elements that constitute a reference point group so as to include the similar point group elements. Then, the dynamic point group extraction unit 15 extracts a dynamic point group from the reference point group on the basis of the grouped reference point group A(121) and the calculation result (the differential point group 114) in the first difference calculation unit 11. In this manner, since the dynamic point group is extracted by referring to the grouped reference point group A(121) in this example embodiment, the dynamic point group is extended to the similar point group elements. This ensures accurate removal of the point group corresponding to the dynamic point group from the differential point group 115 (see FIG. 7). This therefore allows providing a processing device, an abnormality detection system, an abnormality detection method, and a computer-readable medium capable of more accurately identifying an abnormal part.

### Third Example Embodiment

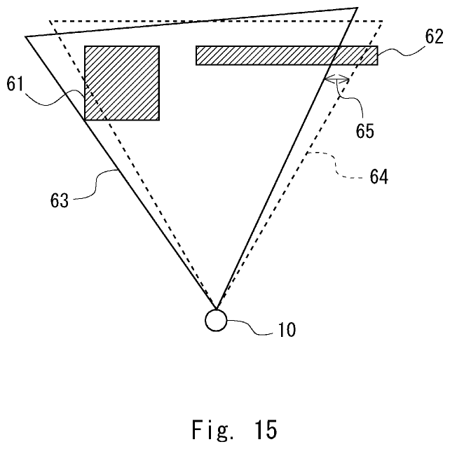

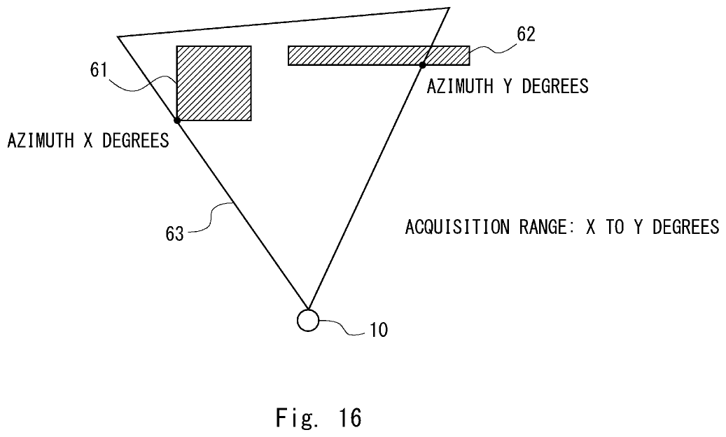

A third example embodiment will be described next. FIGS. 15 and 16 are views illustrating a processing device according to the third example embodiment. As described above, in the present invention, a reference point group is acquired in advance, and then an inspection point group is acquired separately when inspecting an abnormal part of an object to be measured. In this manner, the timing of acquiring a reference point group and the timing of acquiring an inspection point group are different in the present invention. Therefore, as shown in FIG. 15, for example, when three-dimensional position information of objects 61 and 62 to be measured are acquired using the position information acquisition device 10, there is a case where an acquisition range of a reference point group 63 and an acquisition range of an inspection point group 64 are deviated from each other.

Specifically, since a predetermined time elapses after acquiring a reference point group until acquiring an inspection point group, there is a possibility that the position of the position information acquisition device 10 is deviated during this time. Further, in some cases, the position information acquisition device 10 is removed after acquiring a reference point group, and then the position information acquisition device 10 is installed again when acquiring an inspection point group. In such cases, there is a possibility that the installation position of the position information acquisition device 10 is slightly different between when acquiring a reference point group and when acquiring an inspection point group, which causes an acquisition range of the reference point group 63 and an acquisition range of the inspection point group 64 to be deviated from each other. FIG. 15 shows a scan range in the horizontal direction of the position information acquisition device 10.

In this example embodiment, when the acquisition range of the inspection point group 64 and the acquisition range of the reference point group 63 are not the same, a range 65 that is obtained by subtracting the acquisition range of the reference point group 63 from the acquisition range of the inspection point group 64 is removed from the acquisition range of the inspection point group 64.

For example, in this example embodiment, as shown in FIG. 16, the acquisition range (X to Y degrees) of the reference point group 63 is determined on the basis of position information of the position information acquisition device and position information of the reference point group 63. Then, processing of removing a point group 65 (see FIG. 15) outside the acquisition range (X to Y degrees) of the reference point group 63 from the acquisition range of the inspection point group 64 is performed.

Further, a point group outside the acquisition range (X to Y degrees) of the reference point group 63 may be removed by setting configuration information at the time of acquisition of the reference point group 63 to the position information acquisition device 10 when acquiring the inspection point group 64. The configuration information at the time of acquisition of the reference point group 63 may be the position information of the position information acquisition device 10 and the acquisition range (X to Y degrees) of the reference point group 63, for example.

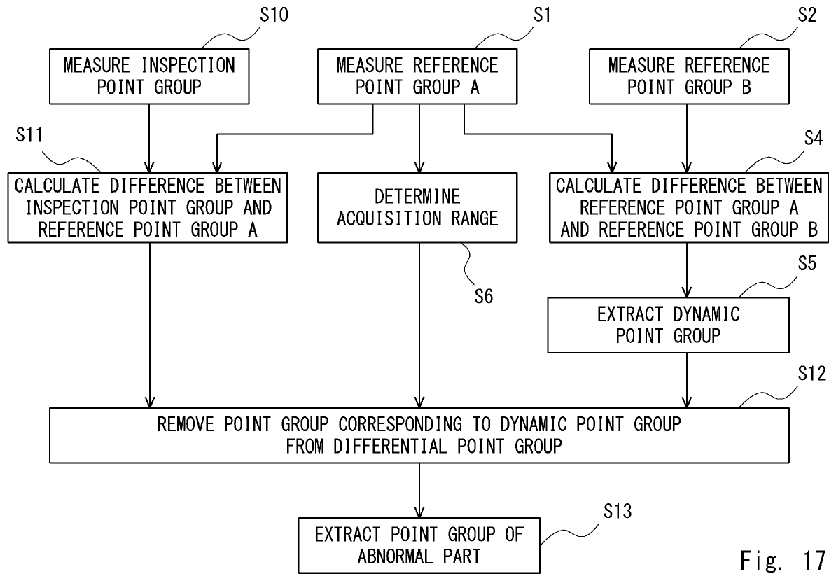

FIG. 17 is a flowchart illustrating the operation of the processing device according to this example embodiment. The operation of the processing device according to this example embodiment shown in the flowchart of FIG. 17 is different from the operation of the processing device 1 according to the first example embodiment (FIG. 3) in that it includes Step S6. The other operation is the same as the operation of the processing device 1 according to the first example embodiment, and therefore redundant description thereof is omitted. Note that this example embodiment may be combined with the processing device according to the second example embodiment.

In this example embodiment also, the reference point groups A and B, which are point groups corresponding to three-dimensional position information of an object to be measured, are acquired in advance by using the position information acquisition device 10 (see FIG. 1) (Steps S1 and S2). Note that, since the timing of acquiring the reference point group A and the timing of acquiring the reference point group B are substantially the same, it is assumed that the acquisition range of the reference point group A and the acquisition range of the reference point group B are the same.

After that, as shown in FIG. 16, the acquisition range (X to Y degrees) of the reference point group A(63) is determined on the basis of the position information of the position information acquisition device 10 and the position information of the reference point group A(63) (Step S6).

Note that the operations of Steps S4 and S5 and Steps S10 and S11 are the same as the operation (FIG. 3) of the processing device 1 according to the first example embodiment.

After that, in Step S12, the point group removal unit 16 removes a point group corresponding to the dynamic point group extracted in the dynamic point group extraction unit 15 from the differential point group generated in the second difference calculation unit 12. In this step, the point group removal unit 16 performs processing of removing the point group 65 (see FIG. 15) outside the acquisition range (X to Y degrees) of the reference point group 63 from the acquisition range of the inspection point group 64.

After that, the abnormal part identification unit 17 identifies an abnormal part of the object to be measured on the basis of the point group corresponding to the dynamic point group and the differential point group from which the point group 65 (see FIG. 15) outside the acquisition range of the reference point group 63 is removed (Step S13 in FIG. 17).

As described above, in this example embodiment, the point group 65 (see FIG. 15) outside the acquisition range (X to Y degrees) of the reference point group 63 is removed from the acquisition range of the inspection point group 64. This prevents the range 65 after subtracting the acquisition range of the reference point group 63 from the acquisition range of the inspection point group 64 from being wrongly detected as an abnormal part.

In the above-described first to third example embodiments, the case of extracting a dynamic point group by using a differential point group between two reference point groups A and B is described. However, in this example embodiment, a dynamic point group may be extracted by using a differential point group among three or more reference point groups. In this case, a differential point group is generated using three or more reference point groups (Step S4 in FIG. 3), and a dynamic point group is extracted by using the generated differential point group (Step S5 in FIG. 3).

For example, in the case of generating a differential point group among three reference point groups A, B and C, each of a difference between the reference point group A and the reference point group B, a difference between the reference point group B and the reference point group C, and a difference between the reference point group C and the reference point group A is calculated, and a differential point group is generated by using those differences.

Although the present invention is described as a hardware configuration in the above example embodiment, it is not limited thereto. The present invention may be implemented by causing a CPU (Central Processing Unit) to execute a computer program to perform given processing.

In the above-described example embodiments, the program can be stored using any type of non-transitory computer readable media and provided to a computer. The non-transitory computer readable media include any type of tangible storage media. Examples of non-transitory computer readable media include magnetic storage media (to be specific, flexible disks, magnetic tapes, and hard disk drives), optical magnetic storage media (to be specific, magneto-optical disks), CD-ROM (Read Only Memory), CD-R, CD-R/W, and semiconductor memories (to be specific, mask ROM, PROM (Programmable ROM), EPROM (Erasable PROM), flash ROM, and RAM (Random Access Memory)). The program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers, or a wireless communication line.

Although the present invention is described above with reference to the example embodiments, the present invention is not limited to the above-described example embodiments. Various changes and modifications as would be obvious to one skilled in the art may be made to the structure and the details of the present invention without departing from the scope of the disclosure.

### REFERENCE SIGNS LIST

1, 2 PROCESSING DEVICE
10 POSITION INFORMATION ACQUISITION DEVICE
11 FIRST DIFFERENCE CALCULATION UNIT
12 SECOND DIFFERENCE CALCULATION UNIT
13 GROUPING UNIT
15 DYNAMIC POINT GROUP EXTRACTION UNIT
16 POINT GROUP REMOVAL UNIT
17 ABNORMAL PART IDENTIFICATION UNIT
20 OBJECT TO BE MEASURED
21, 22 PLANT
23 ABNORMAL PART
26, 27 DYNAMIC POINT GROUP
31, 32 POINT GROUP CORRESPONDING TO DISPLACED PART
33 POINT GROUP CORRESPONDING TO ABNORMAL PART
41, 42, 45, 46 OBJECT TO BE MEASURED
61, 62 OBJECT TO BE MEASURED
63 REFERENCE POINT GROUP
64 INSPECTION POINT GROUP
100 ABNORMALITY DETECTION SYSTEM

1. A processing device comprising:
a first difference calculation unit configured to calculate a difference between a plurality of reference point groups corresponding to three-dimensional position information of an object to be measured;
a dynamic point group extraction unit configured to extract a dynamic point group, the dynamic point group being a point group involving a change from the reference point groups on the basis of a calculation result in the first difference calculation unit;
a second difference calculation unit configured to calculate a difference between an inspection point group acquired after the reference point group and corresponding to three-dimensional position information of the object to be measured and the reference point group, and generate a differential point group;
a point group removal unit configured to remove a point group corresponding to the dynamic point group from the differential point group generated in the second difference calculation unit; and
an abnormal part identification unit configured to identify an abnormal part of the object to be measured on the basis of a differential point group from which the point group corresponding to the dynamic point group is removed.

2. The processing device according to claim 1, wherein the point group removal unit removes a point group corresponding to the dynamic point group from the differential point group when a distance between the differential point group and the dynamic point group is equal to or less than a predetermined threshold.

3. The processing device according to claim 2, wherein the point group removal unit sets the predetermined threshold to become larger as a distance from a point of measurement to the object to be measured becomes longer.

4. The processing device according to claim 2 or 3, wherein the point group removal unit sets the predetermined threshold to become larger as density of the reference point group becomes lower.

5. The processing device according to any one of claims 1 to 4, further comprising:
a grouping unit configured to group point group elements constituting the reference point group so as to include similar point group elements.

6. The processing device according to claim 5, wherein the grouping unit groups together point group elements wherein directions of planes of respective point group elements are approximate to each other.

7. The processing device according to any one of claims 1 to 6, wherein when an acquisition range of the inspection point group and an acquisition range of the reference point group are not the same, a range after subtracting the acquisition range of the reference point group from the acquisition range of the inspection point group is removed from the acquisition range of the inspection point group.

8. An abnormality detection system comprising:
a position information acquisition device configured to acquire three-dimensional position information of an object to be measured; and
a processing device configured to identify an abnormal part of the object to be measured by using three-dimensional position information acquired in the position information acquisition device, wherein
the processing device comprises:
a first difference calculation unit configured to calculate a difference between a plurality of reference point groups corresponding to three-dimensional position information of the object to be measured;
a dynamic point group extraction unit configured to extract a dynamic point group, the dynamic point group being a point group involving a change from the reference point groups on the basis of a calculation result in the first difference calculation unit;
a second difference calculation unit configured to calculate a difference between an inspection point group acquired after the reference point group and corresponding to three-dimensional position information of the object to be measured and the reference point group, and generate a differential point group;
a point group removal unit configured to remove a point group corresponding to the dynamic point group from the differential point group generated in the second difference calculation unit; and
an abnormal part identification unit configured to identify an abnormal part of the object to be measured on the basis of a differential point group from which the point group corresponding to the dynamic point group is removed.

9. An abnormality detection method comprising:
calculating a difference between a plurality of reference point groups corresponding to three-dimensional position information of an object to be measured;
extracting a dynamic point group, the dynamic point group being a point group involving a change from the reference point groups on the basis of a result of the calculation;
calculating a difference between an inspection point group acquired after the reference point group and corresponding to three-dimensional position information of the object to be measured and the reference point group, and generating a differential point group;
removing a point group corresponding to the dynamic point group from the generated differential point group; and
identifying an abnormal part of the object to be measured on the basis of a differential point group from which the point group corresponding to the dynamic point group is removed.

10. A non-transitory computer readable medium storing a program causing a computer to execute an abnormality detection process comprising:
calculating a difference between a plurality of reference point groups corresponding to three-dimensional position information of an object to be measured;
extracting a dynamic point group, the dynamic point group being a point group involving a change from the reference point groups on the basis of a result of the calculation;
calculating a difference between an inspection point group acquired after the reference point group and corresponding to three-dimensional position information of the object to be measured and the reference point group, and generating a differential point group;
removing a point group corresponding to the dynamic point group from the generated differential point group; and
identifying an abnormal part of the object to be measured on the basis of a differential point group from which the point group corresponding to the dynamic point group is removed.
